(19) United States
(12) Patent Application Publication
(10) Pub. No.: US 2011/0008629 A1
(43) Pub. Date: Jan. 13, 2011

(54) STRUCTURAL LAMINATES MADE WITH NOVEL FACING SHEETS

(75) Inventors: Daniel D. Davidson, LaGrange, GA (US); Philip Bush, Laurel, MS (US); Calvin G. Gray, Petal, MS (US)

Correspondence Address: NIXON & VANDERHYE, PC, 901 NORTH GLEBE ROAD, 11TH FLOOR, ARLINGTON, VA, 22203, US

(73) Assignee: Atlas Roofing Corporation, Meridian, MS (US)

(21) Appl. No.: 12/668,289

(22) PCT Filed: Aug. 11, 2008
(86) PCT No.: PCT/US08/09592

§ 371 Date: Sep. 22, 2010

Related U.S. Application Data
(60) Provisional application No. 60/955,304, filed on Aug. 10, 2007.

(51) Int. Cl. B32B 17/10; B32B 37/02

(52) U.S. Cl. 428/442; 156/60

(57) ABSTRACT

A laminated panel comprises at least one facer comprising a coating applied to a facer sheet to provide a coated facer surface, and a thermosetting plastic foam firmly adhered to the coated facer surface. In an example, non-limiting embodiment, the facer sheet comprises a nonwoven glass mat; the coating comprises a coating mixture comprising a mineral pigment and a dried latex; and the thermosetting plastic foam is comprised of an insulation material selected from the group consisting of polyurethane modified polyisocyanurate foam, polyurethane foam, and phenolic-formaldehyde foam. In an example variation, the nonwoven glass mat has the coating applied to two opposing flat surfaces thereof.

This application claims the priority and benefit of U.S. Provisional Patent application 60/955,304, entitled STRUCTURAL LAMINATES MADE WITH NOVEL FACING SHEETS, filed Aug. 10, 2007, which is incorporated herein by reference in its entirety.

### BACKGROUND

I. Technical Field

This invention relates to laminates and foam-filled panel products which are rigid and strong, and more particularly relates to structurally rigid boards of foam which have at least one planar flat side covered with a unique facing sheet.

II. Related Art And Other Considerations

The field of foamed core laminated panels is large and well known in commerce. Over the years, flat rigid sheets and continuous webbed flexible sheets have been used to provide one or both facings (“facers”) for a foamed core panel. The facer sheets have been formed of paper, plastic, aluminum foil, other metals, rubber, wood, and even vegetable-based skins. These facer sheets contain cellular plastic foam between two facers in essentially parallel planes in the form of a laminated “sandwich board” configuration.

One successful laminated panel has been made by Atlas Roofing Corporation by starting with a low cost mat comprised mostly of glass fibers, coating the mat on one side with a simple latex-pigment coating, and then pouring an expandable liquid plastic foam between two such coated mats (using the uncoated side of the glass mats to bind with the glass fibers). Such a product, called Rboard®, is also described in U.S. Pat. No. 5,001,005, and is useful as a building product to, e.g., replace fiber-board sheathing.

A successful Coated Glass Facer (hereinafter “CGF”), also made by Atlas Roofing Corporation, is described in U.S. Pat. No. 5,112,678 and U.S. Pat. No. 5,102,728. In recent years that CGF technology has been improved upon by U.S. Pat. No. 7,138,346 and US Patent Application No. 2007/0042657. The five (5) above-mentioned patents are all incorporated herein by reference.

In general, the strength of bonding between a facer and a foam core for a laminated panel can influence the manner in which the laminated panel is best employed, e.g., the way in which the panel is mounted or affixed to understructure. Some laminated panels, for example, tend to fail when mounted to the understructure using only adhesive, particularly when the laminated panel bears or hosts other elements or other coatings, e.g., stucco, for example. Similar problems have occurred when commercial roofing contractors tried using adhesive without mechanical fasteners to attach certain laminated foam panels directly to a metal deck. Then panel was adhered solely with adhesive, the bond between the foam core and the glass fibers of the facer was not strong enough.

In order to avoid problems that can occur when using only adhesive mounting, and in order to meet standards or recommendations such as the Factory Mutual Wind Uplift ratings, mechanical fasteners are typically used (either alone or as supplements to adhesive) to facilitate mounting of a laminated panel to an understructure.

Many efforts have been made, and continue to be made, to reduce the number of fasteners needed to achieve objectives such as those set forth in the Factory Mutual Wind Uplift ratings. As many as one fastener per two square feet (8 per 16-ft2, or 16 per 32-ft2) is needed in some thin board applications. Stronger facer adhesion could possibly reduce that number of fasteners needed in the same board thickness to six fasteners per 16-ft2 or eleven fasteners per 32-ft2, which is a lot of money in fastener savings per large roof.

Various foam manufacturing formulations have been changed in order to improve facer adhesion. One such revision incorporated the use of acetone as a partial blowing agent. See, e.g., U.S. Provisional Patent application 60/287,388, incorporated herein by reference in its entirety, which shows some success at improving adhesion. Another successful formula additive was the mixed dibasic esters; e.g., the methyl esters of glutaric acid, succinic acid, and adipic acid, that are disclosed in U.S. Pat. No. 6,866,923 (incorporated herein by reference in its entirety) and US Patent Publication 2004/012,6564 and 2005/005, 3780 (both of which are incorporated herein by reference in their entirety).

In recent years, the industry's interest in making an improved facer for foam has shifted toward making a stronger facer for use as a gypsum board cover, replacing the multi-ply paper. A sampling of prior art directed toward various different types of non-woven glass mat webs having various coatings can be found in the following list of U.S. Pat. Nos. (all of which are incorporated herein by reference):

| | | | |
|---|---|---|---|
| 5,965,257 | 6,008,147 | 6,093,485 | 6,187,697 |
| 6,365,533 | 6,368,991 | 6,524,679 | 6,723,670 |
| 6,770,354 | 6,774,071 | 6,808,793 | 6,866,492 |
| 6,875,308 | 6,878,321 | 6,913,816 | |

Thus, for many years a need has existed for improved adhesive strength between a facer such as a coated glass facer and the thermosetting foam core. Various attempts have been made to improve the property known as “Facer Adhesion.”

What is needed, therefore, and an object of the present invention, is to provide a laminated foam board structural panel wherein a facer and foam core are strongly adhered.

### BRIEF SUMMARY

In one of its aspect the technology disclosed herein includes a laminated panel which comprises at least one facer comprising a coating applied to a facer sheet to provide a coated facer surface, and a thermosetting plastic foam firmly adhered to the coated facer surface. In an example, non-limiting embodiment, the facer sheet comprises a nonwoven glass mat; the coating comprises a coating mixture comprising a mineral pigment and a dried latex; and the thermosetting plastic foam is comprised of an insulation material selected from the group consisting of polyurethane modified polyisocyanurate foam, polyurethane foam, and phenolic-formaldehyde foam. In an example variation, the nonwoven glass mat has the coating applied to two opposing flat surfaces thereof.

An example embodiment further comprises two facers, with each of the two facers comprising a coating applied to a facer sheet. Each of the two facers respectively has a coated facer surface. The thermosetting plastic foam is positioned between the two facers and firmly adhered to the coated facer surface of each of the two facers.

In another of its aspects the technology disclosed herein comprises a laminated panel including: a layer of thermosetting plastic foam; a facer (comprising a facer sheet wherein at least one surface of the facer sheet is substantially covered with a coating to form a coated facer surface); and, wherein the at least one coated facer surface is firmly adhered to said thermosetting plastic foam.

In another of its aspects the technology disclosed herein comprises a method of making a thermally insulative building construction panel. The method comprises providing at least one facer (the facer comprising a coating applied to a facer sheet to provide a coated facer surface); and firmly adhering a thermosetting plastic to the coated facer surface. An example, non-limiting mode further comprises applying the coating to the facer sheet, and wherein the coating comprises a coating mixture comprising a mineral pigment and a dried latex. Another example mode further comprises providing two facers (with each of the two facers comprising a coating applied to a facer sheet, thereby for each of the two facers respectively providing a coated facer surface), and firmly adhering the thermosetting plastic foam between the coated facer surfaces of the two facers.

### BRIEF DESCRIPTION OF THE DRAWINGS

The foregoing and other objects, features, and advantages of the invention will be apparent from the following more particular description of preferred embodiments as illustrated in the accompanying drawings in which reference characters refer to the same parts throughout the various views. The drawings are not necessarily to scale, emphasis instead being placed upon illustrating the principles of the invention.

FIG. 1 is a sectioned side view of a laminated panel according to an example embodiment.

FIG. 2 is a sectioned side view of a laminated panel according to another example embodiment.

FIG. 3 is a sectioned side view of a laminated panel according to yet another example embodiment.

FIG. 4 is a sectioned side view of a laminated panel according to still another example embodiment.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other embodiments that depart from these specific details. That is, those skilled in the art will be able to devise various arrangements which, although not explicitly described or shown herein, embody the principles of the invention and are included within its spirit and scope. In some instances, detailed descriptions of well-known devices, circuits, and methods are omitted so as not to obscure the description of the present invention with unnecessary detail. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Prior art laminated panels which comprised foam cores and facers were all made by bringing the foam-forming liquid into contact with the exposed glass fibers of the facer, with the facer having a coating, or other substance such as aluminum foil, on the side of the glass mat opposite the side of foam contact. For boards having two facers, the second or “topside” facer also had the exposed glass fibers laid down against or in contact the foam-forming liquid.

By contrast, in embodiments of the technology disclosed herein, laminated panels comprise at least one facing sheet having a coating adhered to at least one major surface thereof to provide a coated surface, and a thermosetting plastic foam layer adhered to the coated facer surface rather than the raw glass fiber side of the facer. The thermosetting plastic foam is comprised of an insulation material selected from the group consisting of polyurethane modified polyisocyanurate foam, polyurethane foam, and phenolic-formaldehyde foam. Preferably the facing sheet comprises a coated nonwoven glass mat. In an example embodiment, the coating comprises a mineral pigment and a dried latex.

Thus, embodiments of the laminated panel of the technology disclosed herein have adherence of the foam to a coated surface of the facer. The foam core can have facers on one or both sides thereof, but for the sides of the foam core having a facer, it is the coated surface of the facer that is in contact with the foam. Thus, if desired, a “Coated-1-Side” (“C1S”) facer can be employed, but the glass fibers must be exposed and the coating must be adhered to the thermosetting foam.

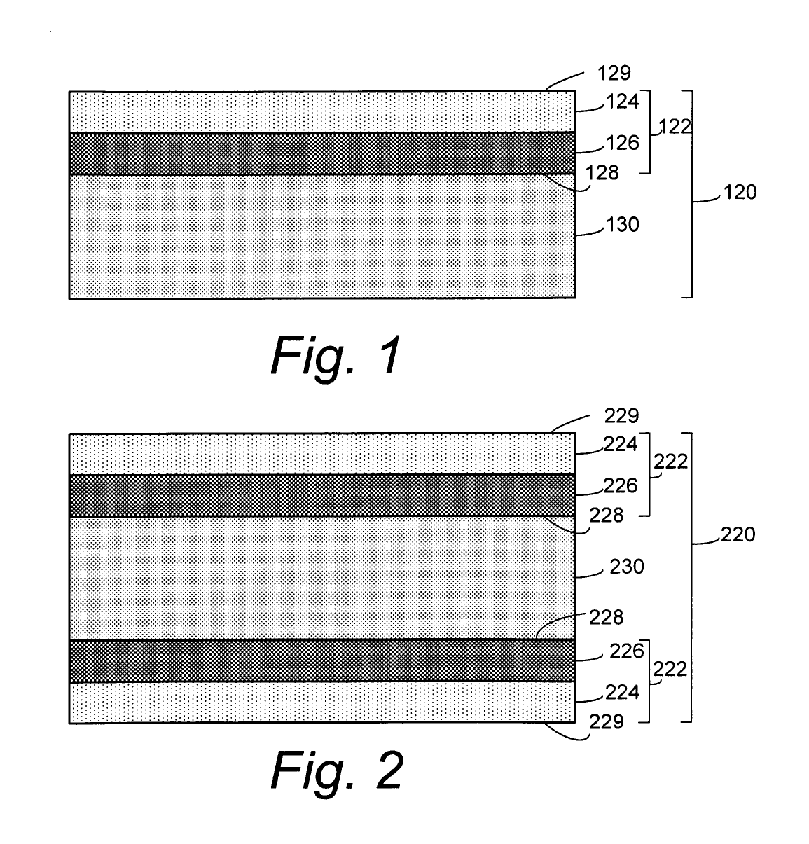

FIG. 1 illustrates an example embodiment of a laminated panel 120, and particularly an example embodiment which employs a coated-1-side (“C1S”) facer. The laminated panel 120 comprises a facer 122 which includes a facer sheet 124 which bears a coating 126 and thus provides a coated facer surface 128. The opposite side or surface 129 of facer sheet 124 (e.g., the surface opposite coated facer surface 128) is uncoated, and as such has exposed the material which comprises the body of facer sheet 124. The laminated panel 120 further comprises a thermosetting foam 130 which is adhered to coated facer surface 128.

FIG. 2 illustrates an example embodiment of a laminated panel 220, and particularly an example embodiment which employs two facers 222, with each of the two facers 222 being a coated-1-side (“C1S”) facer. As understood with reference, for example, to the embodiment of FIG. 1, each coated-1-side facer 222 comprises facer sheet 224 and coating 226 to provide coated facer surface 228. The thermosetting foam 230 is adhered between the two coated facer surfaces 228.

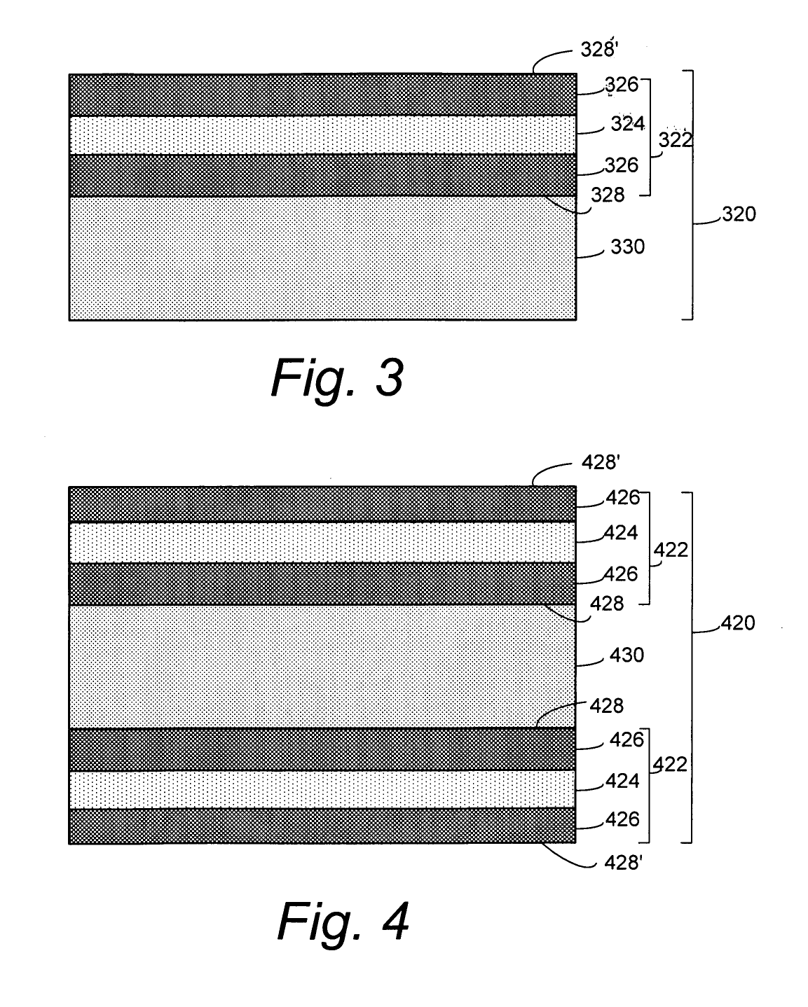

FIG. 3 illustrates an example embodiment of a laminated panel 320 which employs one coated-2-side (“C2S”) facer 322. The laminated panel 320 comprises a facer 322 comprising facer sheet 324. Facer sheet 324 comprises, on both of its opposed major surfaces, a coating 326 to provide opposite coated facer surfaces 328 and 328′. One of the coated facer surfaces, i.e., coated facer surfaces 328, has thermosetting foam 330 adhered thereto. In the particular embodiment show in FIG. 3, the other coated facer surface, i.e., coated facer surface 328′, happens not to have thermosetting foam adhered thereto.

FIG. 4 illustrates an example embodiment of a laminated panel 420 which employs two coated-2-side (“C2S”) facers 422. As understood with reference, for example, to the embodiment of FIG. 3, each coated-2-side facer 422 comprises facer sheet 424 and two coatings 426 to provide the oppositely coated facer surfaces 428 and 428′. The thermosetting foam 430 is adhered between the two coated facer surfaces 428 of the two facers 422.

In example embodiments such as those described above, the facer sheet (e.g., the body or main material of the facer sheet) can comprise a non-woven glass mat. Non-limiting examples of coated non-woven glass mat include those of U.S. Pat. No. 7,138,346, which is incorporated herein by reference. Thus, in example embodiments in which one of the surfaces of the facer sheet is uncoated, the uncoated surface can have exposed glass fibers, and those exposed glass fibers can be exposed for special uses.

Suitable facer sheet materials other than non-woven glass are also possible, including those taught in the example structures of patent documents which have already been incorporated herein by reference.

As a non-limiting example, the coatings for each of the example embodiments described above can comprise a mineral pigment and a dried latex. The prior art coating mixes can be utilized for the coatings of the example embodiments. For example, in one mode, filler materials containing some naturally occurring inorganic binder are deliberately chosen. These fillers with naturally occurring binders must be of a suitable mesh size. The minimum allowable quality is where at least 85% by weight of the filler passes a 200-mesh screen (Grade 85/200). Examples of such fillers having the naturally occurring binder are, but are not limited to: limestone containing quicklime (CaO), clay containing calcium silicate, sand containing calcium silicate, aluminum trihydrate containing aluminum oxide, and magnesium oxide containing either the sulfate or chloride of magnesium, or both. The filler, gypsum, can be both a mineral pigment (as gypsum dihydrate) and a binder (as gypsum hemi-hydrate).

The thermosetting foams used in the example embodiments of laminated panels are all those plastic resins which can be blown into a cellular, foamed structure by any known blowing agent, and which become rigid solids by catalyzed reaction. In some example embodiments, the structural laminates have a thermosetting plastic foam between two facers, with the foam contacting a coated surface of a facer used in the laminate.

Example embodiments are described below, along with facer adhesion strength measurements therefor. To measure facer adhesion strength, many technical leaders like to use the “Rolling Load Emulator” a device to measure the facers' resistance to separation when a heavy load is run over the laminated foam board multiple times, often with the waterproofing membrane attached. Another test used is called “The Peel Strength Test.” This is an adaptation from standards used chiefly in the textile industry, known as Federal Standard 191A—Method 5970. In this test, a two-inch width of facer is pulled from a laminated foam board by a tensile tester. The average load throughout the duration of the test is recorded as is the load at maximum load. Several other data points can be recorded. The many tests run on examples from the work published hereinbelow was performed by the Bodycote Testing Group of Mississauga, Canada.

### Example-1

### Coating Batch #1

A batch of coating mixture is made by adding 2620 pounds of water to a mixing tank having a low speed mixer. This is followed by 80 pounds of a sodium salt of poly-naphthylmethanesulfonate dispersing agent, such as Galoryl® DT 400 N. Then is added 1300 wet pounds (682.5 dry pounds) of a carboxylated SBR latex, such as Styrofan® ND5406, followed by 11,000 pounds of 85/200 (85% passes a 200-mesh screen) limestone that contains about 70 pounds of calcined lime (CaO). This produces a 15,000-pound batch of coating mixture having about 78.1% solids and with a viscosity of about 500 centipoise (cps) at 25° C. The quicklime (CaO) content is about 0.6% by weight on the total dry-weight basis. The latex solids comprise about 5.8% on the dry weight basis.

This coating is next applied to a low cost glass mat such as Johns-Manville Dura-Glass® 7503, which is sold as a 1.45-pounds per hundred square feet non-woven glass mat. In actual practice, these rolls of glass mat weighed about 1.42-lbs/100 ft2.

In the Prior Art mode, this coated 1.45#/Cft2 glass mat was converted into laminated foam panels by engaging the foam-forming liquid onto the exposed glass fibers of both top and bottom facers. The laminated foam panels were tested, and the results appear in TABLE 1, below. The average peel-resistance strength of less than 1-pound (actual=0.757) total maximum load is very low by any standard, and easily accounts for prior art failures when it was assumed this bond was much stronger.

The run of coated glass mat that developed into the surprisingly much higher Peel Strength data began with a batch of coating made with acrylic latex and a limestone having a distinctive yellow color, as shown in EXAMPLE-2, below.

### Example 2

### Coating Batch #2

The coating batch of EXAMPLE-2 was made utilizing 1876-Lbs water, 42-Lbs Galoryl® DT 400 N, 1234-Lbs Dow's NeoCAR-820 all-acrylic latex, 33-Lbs Engelhard W-1241 (dispersed yellow colorant), and 8815-Lbs of Franklin Mineral's Lowell 90/200 limestone. This batch had a 78.4% total solids, which gave a viscosity of 500cPs. The Lowell limestone does not contain any significant amounts of lime.

When the Coating Batch #2 was applied to a non-woven glass mat using both Saint-Gobain's “Vetrotex 2.10 Facer Mat” and Dura-Glass® 7594 from Johns Manville (2.1#/Cft2), one segment of the long run was rejected and moved to costly warehouse facilities. Later, it was taken to the coating line and the uncoated (bare glass mat) side was coated with the ordinary EXAMPLE 1 coating made with SBR latex.

Finished rolls of this Coated-2-Sides (“C2S”) Coated Glass Facer were next shipped to a manufacturing plant where laminated foam board insulation is made on a continuous double-belt laminator. It is not important to the invention whether or not either coated glass mat is C2S or C1S (Coated-1-Side). It is required only that one facer has a coated side adhered to the thermosetting foam. Neither is it important that the thermosetting foam be comprised of polyiso foam. It could be any 2-part thermosetting foam, such as a modern base-catalyzed phenol-formaldehyde.

The C2S facer was converted into a laminated foam product resembling ACFoam-III, however, it was much different because the foam was poured against the yellow coated side of the C2S. To support finger-pulling observations, samples of this material were sent to Bodycote Materials Testing, to establish whether or not the surface adhesion had improved. The test data received from Bodycote are shown in TABLE 2 herein below. Every one of the finished results of TABLE 2 show significant increases in strength, as determined by the Peel Strength Test, which is described next.

To quantify facer adhesion, it was agreed to use the same test utilized in the textile industry whereby a plastic film is “permanently” adhered to a fabric. The test name is: “Federal Test Method Standard No. 191A—Method 5970.” The SCOPE of the test is: “This method is intended for determining the resistance to separation of continuous film type coatings from cloth.” After proper laboratory temperature and humidity conditioning, two inch (2″) wide by six inch (6″) long samples are cut. Each specimen is manually separated at one end for a distance of two inches (2″). Usually a razor blade is used to separate the facer without taking any foam still attached to the facer. The board section is held by the immovable clamp, and the facer is clamped into the movable jaws.

The movable clamp must have a speed of 12.0+/−0.5 inches per minute for separating the facer from the board. A minimum length of 3-inches of facer must be separated by the testing machine. It was discovered that when using lighter weight glass mats within the facer, the sample might break before that 3-inch minimum was obtained. However, it was also noticed that the maximum load data was no different if the sample broke or if it did not break. Therefore, it was decided to use the “Load at Max Load” data. Interestingly, the data under “Load at Max Load” is given by Bodycote in “Foot-Pounds” (lbf).

At this point, it became apparent that a further analysis was required. The scientific conclusions needed were not supplied by comparing a lightweight glass mat; e.g., Johns Manville #7503, about 1.45#/Cft2, coated on one side, with a heavier weight glass mat; Saint-Gobain “Vetrotex” weighing about 2.1 #/Cft2, and coated on both sides.

This plan of analysis began by making CGF from two weights of glass, and having the common SBR coating on one side of all mats, with one exception. Since one test must be made with the Acrylic batch showing, but the foam must be attached to the glass fibers, it was decided to make a run of 2.1#/Cft2 with the Acrylic batch on one side only. (These data are in TABLE-3.) Other than that, all laminated foam panels tested used the SBR batch of EXAMPLE-1 for the exposed side.

Next, the two standard coating batches were used to coat the C1S product made from two different weights of glass mat. These Trials all used both the Johns Manville #7503, weighing about 1.45#/Cft2, and the Saint-Gobain “Vetrotex 2.10 Facer Mat” weighing about 2.1 #/Cft2. The same batches of coating used on the 1.45-lb glass mat were used throughout the second run on the 2.1-lb glass.

The results from the controlled experiment just described appear in four (4) tables included hereinbelow; e.g., TABLE 3, TABLE 4, TABLE 5 and TABLE 6. The prior art data are seen in the odd numbered tables; e.g., TABLE 3 and TABLE 5, while the even numbered tables; e.g., TABLE 4 and TABLE 6 show the improvements of the technology disclosed herein.

Comparisons between the strength tests shown in TABLE 4 and TABLE 3 are as valid as can be arranged. TABLE 4 contains data from both SBR and Acrylic coated facers adhered to the foam.

The average adhesion test results of TABLE 4 (5.34-1b0 are about 8.3 times the average adhesion strength of TABLE 3. (0.646-lbf) Likewise, when comparing data that used the lowest cost raw glass mat available; e.g., the 1.45#/Cft2, the improvement seen in TABLE 6 (2.992-lbf) is still substantial compared to the 0.651-lbf of TABLE 5, but only 4.6-times the old values.

It appears that when placing foam next to, and intermixed with, the exposed glass fibers, it does not matter very much whether the glass fibers came from a light-weight (1.45#/Cft2), glass mat or the 45% heavier (2.1#/Cft2) glass mat. All three Prior Art tables have test results in a tight pattern; i.e., 0.757-lbf; 0.646-lbf; and 0.651-lbf.

In contrast, when placing foam next to either coating, the average of all tests made on the heavier glass (2.1 #/Cft2), which means combining TABLES 2 and 4, is 5.27-lbf, which is about 76% better than the lighter weight (1.45#/Cft2), which had a 2.992-lbf result (TABLE 6).

Nearly all of the peel tests on the lightweight raw mat, (1.45#/Cf2 based CGF), broke before the minimum 3-inches had been peeled back. Several tests made on the heavier glass mat (2.1#/Cft2) likewise broke too early. Specifically, when testing the 2.1#/Cf2 based CGF, the only breaks that occurred happened when an acrylic based coating was adhered to the foam. During the series of tests, it was observed that a coating based upon an all-acrylic latex may have had better adhesion to foam than a coating based upon all-SBR (Styrene-Butylene-Rubber) latex. Unfortunately, the Peel Strength Test procedure that was used could not quantify the difference, probably because of the breaks before 3-inches was peeled when testing the all-acrylic latex based coating. While the major embodiment of this invention is simply placing the foam against the coating on a glass mat, another embodiment distinguishes the superior adhesive strength of acrylic latex-based coatings over those coatings made with SBR.

It was not possible to discern a difference between the Peel Strength of Acrylic coated adhered to foam vs SBR coated next to foam using this particular test, so no attempt is made to show a difference. It is believed, however, that other test methods might show a difference between latexes being used and tested in similar coatings and finished laminated foam panels.

The technology disclosed herein thus provides a thermosetting plastic foam laminated panel comprising at least one facing sheet firmly adhered to said thermosetting plastic foam, wherein the facing sheet has at least one side covered with a coating; and, said coating is the side firmed adhered to said thermosetting plastic foam.

In one of its aspects, the disclosed technology includes a thermosetting plastic foam laminated panel comprising at least one facing sheet having a coating firmly adhered to at least one planar surface of said thermosetting plastic foam laminate, said coating containing a mineral pigment and a dried latex.

The disclosed technology further concerns a thermally insulative building construction panel comprising a first layer comprising a nonwoven glass mat wherein both sides have been coated with a mixture substantially comprised of mineral fillers and dried plastic latex; a second layer comprising a thermosetting plastic foam insulation material; and, a third layer comprising any facing material that has approximately the same dimensional stability as the first nonwoven glass mat layer.

Thus, in accordance with one aspect of the technology disclosed herein, a thermally insulative building construction panel is comprised of a first or bottom sheet that is comprised of nonwoven glass mat coated on at least the top side which comes into contact with the foam-forming liquid of a 2-part thermosetting foam. The finished panels made utilizing the superior adhesive strength can perform better in a variety of building construction locations. The use of liquid foam-forming chemicals is reduced because the smooth surface of the coating does not break up the low density foam as does the rough surface of multiple exposed ends of fibers.

An advantage of the technology disclosed herein is that fewer Factory Mutual approved fasteners will be required to achieve any given wind uplift test required.

Another advantage of the technology disclosed herein is that the structural panels will have higher flexural test strength than similar looking prior-art panels.

Yet another advantage of the technology disclosed herein is that because of added strength, it may be able to utilize thinner panels than heretofore used.

Still another advantage is that less liquid chemicals can make the same thickness of foam due to no destruction of foam-forming as is the case with fibers.

Although the description above contains many specificities, these should not be construed as limiting the scope of the invention but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Prior Art
Foam-to-Fibers

| | Load at |
|---|---|
| Raw Glass | Max Load, |
| Mat Weight | as lbf |
| 1.45#/cf² | 0.689 |
| 1.45#/cf² | 0.754 |
| 1.45#/cf² | 0.741 |
| 1.45#/cf² | 0.668 |
| 1.45#/cf² | 0.760 |
| 1.45#/cf² | 0.701 |
| 1.45#/cf² | 0.666 |
| 1.45#/cf² | 0.789 |
| 1.45#/cf² | 0.847 |
| 1.45#/cf² | 0.722 |
| 1.45#/cf² | 0.748 |
| 1.45#/cf² | 0.766 |
| 1.45#/cf² | 0.842 |
| 1.45#/cf² | 0.613 |
| 1.45#/cf² | 0.837 |
| 1.45#/cf² | 0.689 |
| 1.45#/cf² | 0.906 |
| 1.45#/cf² | 0.885 |

Mean = 0.757

TABLE 2
New Art
Foam-to-Coating

| | Load at |
|---|---|
| Raw Glass | Max Load, |
| Mat Weight | as lbf |
| 2.1#/cf² | 5.955 |
| 2.1#/cf² | 4.801 |
| 2.1#/cf² | 4.700 |
| 2.1#/cf² | 5.396 |
| 2.1#/cf² | 4.832 |
| 2.1#/cf² | 6.087 |
| 2.1#/cf² | 4.527 |
| 2.1#/cf² | 4.870 |
| 2.1#/cf² | 5.608 |
| 2.1#/cf² | 4.231 |
| 2.1#/cf² | 4.327 |
| 2.1#/cf² | 6.334 |
| 2.1#/cf² | 5.051 |
| 2.1#/cf² | 6.274 |
| 2.1#/cf² | 3.916 |
| 2.1#/cf² | 5.266 |
| 2.1#/cf² | 5.550 |
| 2.1#/cf² | 5.123 |
| 2.1#/cf² | 4.954 |
| 2.1#/cf² | 4.906 |
| 2.1#/cf² | 5.144 |
| 2.1#/cf² | 6.246 |
| 2.1#/cf² | 6.021 |
| 2.1#/cf² | 4.413 |

Mean = 5.189

TABLE 4
New Art
Foam-to-Coating

| | Load at |
|---|---|
| Raw Glass | Max Load, |
| Mat Weight | as lbf |
| 2.1#/cf² | 7.429 |
| 2.1#/cf² | 4.826 |
| 2.1#/cf² | 4.179 |
| 2.1#/cf² | 6.775 |
| 2.1#/cf² | 6.765 |
| 2.1#/cf² | 7.581 |
| 2.1#/cf² | 5.098 |
| 2.1#/cf² | 6.086 |
| 2.1#/cf² | 4.245 |
| 2.1#/cf² | 6.838 |
| 2.1#/cf² | 5.151 |
| 2.1#/cf² | 4.605 |
| 2.1#/cf² | 6.008 |
| 2.1#/cf² | 5.660 |
| 2.1#/cf² | 5.789 |
| 2.1#/cf² | 6.224 |
| 2.1#/cf² | 4.123 |
| 2.1#/cf² | 4.720 |
| 2.1#/cf² | 4.726 |
| 2.1#/cf² | 4.518 |
| 2.1#/cf² | 3.514 |
| 2.1#/cf² | 4.953 |
| 2.1#/cf² | 4.196 |
| 2.1#/cf² | 4.188 |

Mean = 5.340

TABLE 3
Prior Art
Foam-to-Fibers

| | Load at |
|---|---|
| Raw Glass | Max Load, |
| Mat Weight | as lbf |
| 2.1#/cf² | 0.753 |
| 2.1#/cf² | 0.601 |
| 2.1#/cf² | 0.805 |
| 2.1#/cf² | 0.546 |
| 2.1#/cf² | 0.924 |
| 2.1#/cf² | 0.395 |
| 2.1#/cf² | 0.467 |
| 2.1#/cf² | 0.552 |
| 2.1#/cf² | 0.937 |
| 2.1#/cf² | 0.644 |
| 2.1#/cf² | 0.385 |
| 2.1#/cf² | 0.740 |

Mean = 0.646

TABLE 6
New Art
Foam-to-Coating

| | Load at |
|---|---|
| Raw Glass | Max Load, |
| Mat Weight | as lbf |
| 1.45#/cf² | 3.001 |
| 1.45#/cf² | 2.785 |
| 1.45#/cf² | 3.811 |
| 1.45#/cf² | 3.564 |
| 1.45#/cf² | 2.951 |
| 1.45#/cf² | 3.956 |
| 1.45#/cf² | 3.128 |
| 1.45#/cf² | 3.748 |
| 1.45#/cf² | 4.160 |
| 1.45#/cf² | 1.803 |
| 1.45#/cf² | 1.799 |
| 1.45#/cf² | 3.160 |
| 1.45#/cf² | 3.805 |
| 1.45#/cf² | 0.690 |
| 1.45#/cf² | 1.783 |
| 1.45#/cf² | 1.231 |
| 1.45#/cf² | 4.012 |
| 1.45#/cf² | 4.175 |
| 1.45#/cf² | 3.027 |
| 1.45#/cf² | 3.767 |
| 1.45#/cf² | 3.014 |
| 1.45#/cf² | 3.083 |
| 1.45#/cf² | 3.358 |
| 1.45#/cf² | 3.954 |

Mean = 2.992

TABLE 5
Prior Art
Foam-to-Fibers

| | Load at |
|---|---|
| Raw Glass | Max Load, |
| Mat Weight | as lbf |
| 1.45#/cf² | 0.603 |
| 1.45#/cf² | 0.920 |
| 1.45#/cf² | 0.559 |
| 1.45#/cf² | 0.536 |
| 1.45#/cf² | 0.649 |
| 1.45#/cf² | 0.674 |
| 1.45#/cf² | 0.368 |
| 1.45#/cf² | 0.659 |
| 1.45#/cf² | 0.752 |
| 1.45#/cf² | 0.781 |
| 1.45#/cf² | 0.524 |
| 1.45#/cf² | 0.789 |

Mean = 0.651

What is claimed is:

1. A laminated panel comprising:
at least one facer comprising a coating applied to a facer sheet to provide a coated facer surface;
a thermosetting plastic foam firmly adhered to the coated facer surface.

2. The panel of claim 1, wherein the coating comprises a coating mixture comprising a mineral pigment and a dried latex.

3. The panel of claim 1, wherein the thermosetting plastic foam is comprised of an insulation material selected from the group consisting of polyurethane modified polyisocyanurate foam, polyurethane foam, and phenolic-formaldehyde foam.

4. The panel of claim 3, wherein the thermosetting plastic foam is comprised of polyurethane modified polyisocyanurate foam.

5. The panel of claim 1, wherein the facer sheet comprises a nonwoven glass mat.

6. The panel of claim 5, wherein the nonwoven glass mat has the coating applied to two opposing flat surfaces thereof.

7. The panel of claim 5, wherein an uncoated surface of the facer sheet has exposed glass fibers.

8. The panel of claim 1, wherein the facer sheet has the coating applied to two opposing flat surfaces thereof.

9. The panel of claim 1, further comprising two facers, and wherein each of the two facers comprising a coating applied to a facer sheet, thereby for each of the two facers respectively providing a coated facer surface;
the thermosetting plastic foam being positioned between the two facers and firmly adhered to the coated facer surface of each of the two facers.

10. A laminated panel comprising:
a layer of thermosetting plastic foam;
a facer comprising a facer sheet wherein at least one surface of the facer sheet is substantially covered with a coating to form a coated facer surface, and
wherein the at least one coated facer surface is firmly adhered to said thermosetting plastic foam.

11. The panel of claim 10, wherein the thermosetting plastic foam is comprised of an insulation material selected from the group consisting of polyurethane modified polyisocyanurate foam, polyurethane foam, and phenolic-formaldehyde foam.

12. The panel of claim 10, wherein the facer sheet comprises a coated nonwoven glass mat.

13. The panel of claim 10, wherein the coated facer sheet has coating on two opposed flat surfaces thereof.

14. A method of making a thermally insulative building construction panel comprising:
providing at least one facer, the facer comprising a coating applied to a facer sheet to provide a coated facer surface;
firmly adhering a thermosetting plastic to the coated facer surface.

15. The method of claim 14, further comprising applying the coating to the facer sheet, and wherein the coating comprises a coating mixture comprising a mineral pigment and a dried latex.

16. The method of claim 14, wherein the thermosetting plastic foam is comprised of an insulation material selected from the group consisting of polyurethane modified polyisocyanurate foam, polyurethane foam, and phenolic-formaldehyde foam.

17. The method of claim 16, further comprising providing the at least one facer as a facer sheet comprising a coated nonwoven glass mat.

18. The method of claim 17, wherein the nonwoven glass mat has the coating applied to two opposing flat surfaces thereof.

19. The method of claim 14, further comprising providing the at least one facer as a facer sheet comprising the coating applied to two opposing flat surfaces thereof.

20. The method of claim 14, further comprising providing two facers, each of the two facers comprising a coating applied to a facer sheet, thereby for each of the two facers respectively providing a coated facer surface;
firmly adhering the thermosetting plastic foam between the coated facer surfaces of the two facers.
